(19) United States
(12) Patent Application Publication
(10) Pub. No.: US 2004/0201204 A1
(43) Pub. Date: Oct. 14, 2004

(54) Cart for inflatable beds

(76) Inventor: A. Ralph Haire, Thomasville, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/409,035

(22) Filed: Apr. 8, 2003

(51) Int. Cl. B62B 3/00

(52) U.S. Cl. 280/639

(57) ABSTRACT

There is provided a cart for transporting inflatable or foldable mattresses and a vehicle with a storage compartment for storing the cart. The cart includes a top tray, a bottom tray, wheels, and a support frame. The top tray includes extendable portions mounted to a stationary portion so that the top tray can be converted from a contracted configuration to an extended configuration having a length longer than the length of the contracted configuration. The cart provides transport for folded mattresses in the contracted configuration and provides support for unfolded mattresses in the extended configuration. The support frame connects the top tray to the bottom tray and wheels and allows the top tray to be lowered from an operable position substantially above the bottom tray and wheels to a storage position where the top tray is proximate the bottom tray and wheels. The storage compartment on the vehicle advantageously is located on the vehicle between the passenger cabin and the rear wheel well and includes a shelf which extends outward and supports the cart in the storage position, so that the cart may be inserted into the storage compartment.

### FIELD OF THE INVENTION

The present invention relates generally to carts for transporting inflatable or foldable mattresses to and from a vehicle. More particularly the invention relates to carts with extendable top trays that support multiple folded inflatable mattresses when the top tray is in a contracted configuration and that support individual unfolded inflatable mattresses for cleaning purposes when the tray is in an extended configuration. The cart is also collapsible from an operable position to a storage position, and a storage compartment on the exterior of a vehicle is provided to hold the cart when it is in the storage position.

### BACKGROUND OF THE INVENTION

Within the health care industry, many patient beds are not owned by a hospital or nursing home, rather the beds are often rented items prescribed by doctors. Beds are chosen so that, for example, a certain type of patient may be prescribed a type of bed that caters best to the injury or illness of the patient. Private companies fulfill these bed prescriptions and, as such, will deliver and remove beds accordingly. Thus it is important that the bed rental company be able to quickly deliver and remove the prescribed beds.

One of these types of beds is an inflatable bed, which can be very useful in the prevention of bedsores. These inflatable beds include a mattress in the form of a closed bag, which is inflated by way of a separate blower pump. These blowers can weigh 35 to 50 pounds and thus transporting blowers along with the mattresses in and out of the hospital or nursing home can be cumbersome. In addition, the bed rental company must disinfect the entire inflatable mattress between rentals, which can be difficult to do without appropriate fixtures to support an unfolded inflatable mattress.

Not only must the inflatable mattresses and pumps be transported in a vehicle to and from the hospitals and nursing homes, but the cart or other device used to deliver the mattresses and pumps from the vehicle to the buildings must also be transported in the vehicle. Such carts can occupy a large amount of storage space within a vehicle and may be cumbersome to load and unload into a vehicle. Furthermore, the carts must also be stored in a clean environment within the vehicle so that the carts will not contaminate the inflatable mattresses and pumps during delivery to and from the vehicle.

Therefore, a need exists for a cart specifically intended for transporting inflatable mattresses and facilitating the disinfection of the mattresses. Furthermore, a need also exists for convenient and efficient transportation of this cart between health care providers.

### BRIEF SUMMARY OF THE INVENTION

The invention addresses the above needs and achieves other advantages by providing a system comprising a vehicle and a cart for transporting and cleaning beds such as foldable mattresses. The vehicle includes a storage compartment on a side of the vehicle located between the passenger compartment and the rear wheel well for stowing of the cart. The storage compartment has an interior length dimension less than the length of an unfolded mattress, and the cart comprises a top tray with a pair of extendable portions that are extendable in a length direction such that the top tray can be converted from a contracted configuration to an extended configuration by extending the extendable portions. The top tray further defines a length, and in the extended configuration the top tray has a length sufficient to support an unfolded mattress for cleaning operations to be performed on the mattress. In the contracted configuration the top tray is sufficiently short to be placed within the interior length dimension of the storage compartment.

The cart further comprises a plurality of wheels and a support frame for supporting the top tray on the wheels. The support frame allows the cart to be contracted from an operable position where the top tray is elevated substantially above the wheels to a storage position where the top tray is lowered to be proximate the wheels. In the storage configuration the height of the cart is short enough for the cart to fit into the storage compartment on the vehicle.

In one embodiment of the system, the top tray of the cart includes a stationary portion and two extendable portions that are each extendable in the length direction away from the stationary portion an equal distance in opposite directions. Advantageously, the extended configuration defines a top tray with a length approximately twice the length in the contracted configuration. Furthermore, the support frame includes two scissor-like supports attached to the transverse edges of the top tray that define the width of the top tray. In another embodiment, the cart includes a bottom tray disposed below the top tray, proximately above the wheels, and between the two scissor-like supports. The top tray includes straps, in a further embodiment of the system, so that the folded mattresses may be secured to the top tray of the cart during transport.

The storage compartment of the vehicle includes a shelf in one embodiment of the system. The shelf is advantageously attached with linear bearings and may be extended from an interior position within the storage compartment to an exterior position substantially outside the storage compartment. By placing the cart upon the shelf in the exterior position then converting the shelf to the interior position, the cart may be stowed within the storage compartment.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a perspective view of the cart in the operable position and contracted configuration and of the storage compartment with the shelf in the exterior position;

FIG. 2 is a perspective view of the cart in the operable position and contracted configuration with folded mattresses positioned on the top tray and pumps positioned on the bottom tray;

FIG. 3 is a perspective view of the cart in the operable position and extended configuration;

FIG. 4 is a perspective view of the cart in the operable position and extended configuration with an unfolded mattress positioned on the top tray;

FIG. 5 is a perspective view of the cart in the storage position and contracted configuration partially positioned on the storage compartment shelf in the exterior position; and

FIG. 6 is a perspective view of the cart in the storage position and contracted configuration positioned on the storage compartment shelf in the exterior position, just prior to the shelf being moved into the interior position.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

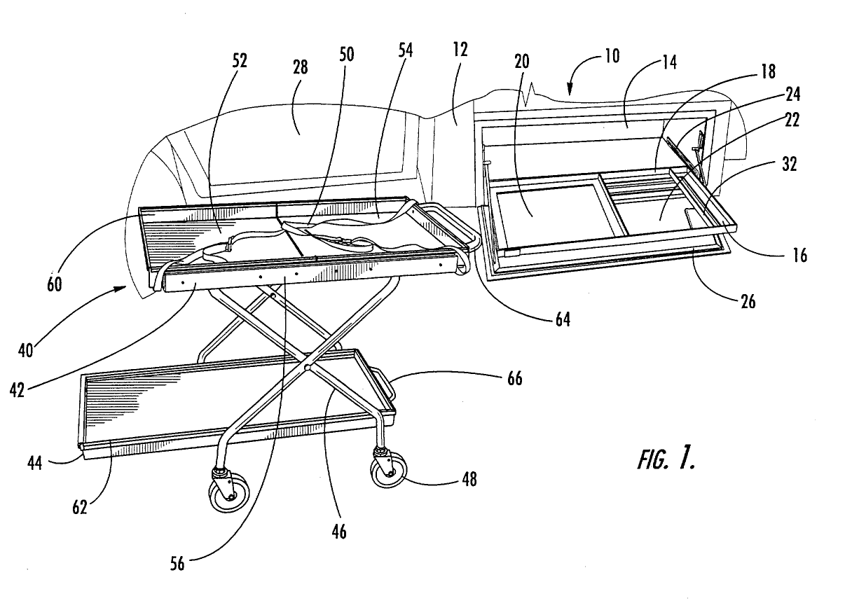

FIG. 1 illustrates an embodiment of the mattress transport system 10 that includes a cart 40 and a storage compartment 14 on a vehicle 12. The cart 40 is provided to support multiple inflatable or foldable mattresses, as well as accessories for the mattresses, from a health care facility such as a hospital or nursing home to the vehicle 12 and from the vehicle back to the facility. The cart 40 also provides a surface for supporting an unfolded inflatable mattress so that an operator may disinfect the inflatable mattress. When the cart 40 is not in use it is intended to be stowed in the storage compartment 14 of the vehicle 12.

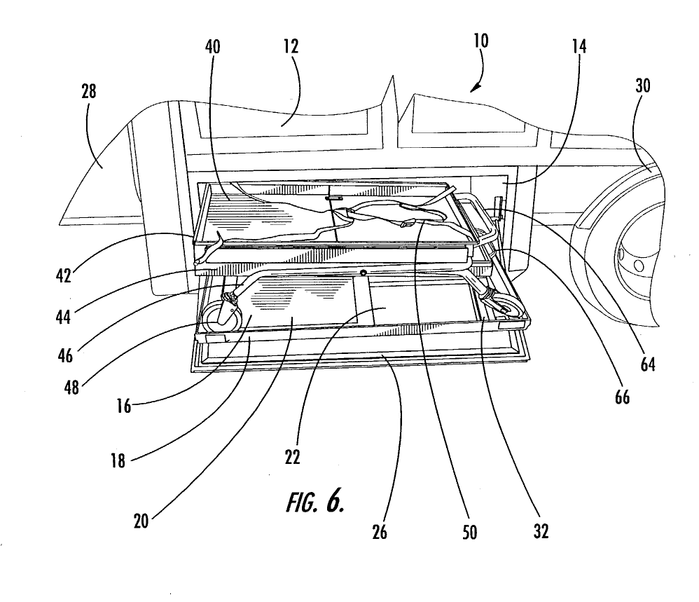

Cart 40 includes a top tray 42 and preferably includes a bottom tray 44. Top tray 42 is extendable and in the contracted configuration of the top tray illustrated in FIG. 1, the top tray provides a surface to support multiple folded inflatable mattresses or other types of beds for transport. Wheels 48 advantageously include four separate wheels or casters to allow the cart 12 to be conveniently transported by an operator. Top tray 42 is connected to the wheels 48 and bottom tray 44 by the support frame 46 that in the illustrated embodiment of FIG. 1 are scissor-like supports. The two scissor-like supports 46 allow the vertical height of the cart 40 to be changed from an operable position in which the top tray 42 is raised substantially above the bottom tray 44, as shown in FIG. 1, to a storage position in which top tray is lowered to be proximate the bottom tray, as shown in FIG. 6. The scissor-like supports 46 pivot about a point located midway between the top tray 42 and the bottom tray 44, and as the top tray is lowered toward the bottom tray, the ends of the supports connecting to the top tray expand apart in the length direction, just as the ends connecting to the bottom tray expand apart in the length direction as the top tray is lowered. Because the wheels 48 are attached to the support frame 46, the wheels also expand away from each other in the length direction as the top tray 42 is lowered from the operable position to the storage position. However, it should be appreciated that other designs for the support frame 46 that allow the top tray 42 to be vertically lowered are incorporated within the present invention.

The two top ends of the scissor-like supports 46 are connected to the top tray 42 in such a way that one end remains in a fixed location relative to the top tray and the other end of the supports moves in the length direction while the top tray is raised or lowered. Likewise, one end of the supports 46 connected to the bottom tray 44 remains in a fixed location relative to the bottom tray and the other end of the supports moves in the length direction while the top tray is raised and lowered. In one embodiment of the present invention, the fixed ends of the supports 46 are connected to the respective tray 42 or 44 using a bushing that completely encloses the support end. The moveable ends are removably attached to the respective tray 42 or 44 with a hook-shaped retainer such that the moveable end may be operatively contained and removed as desired by the operator.

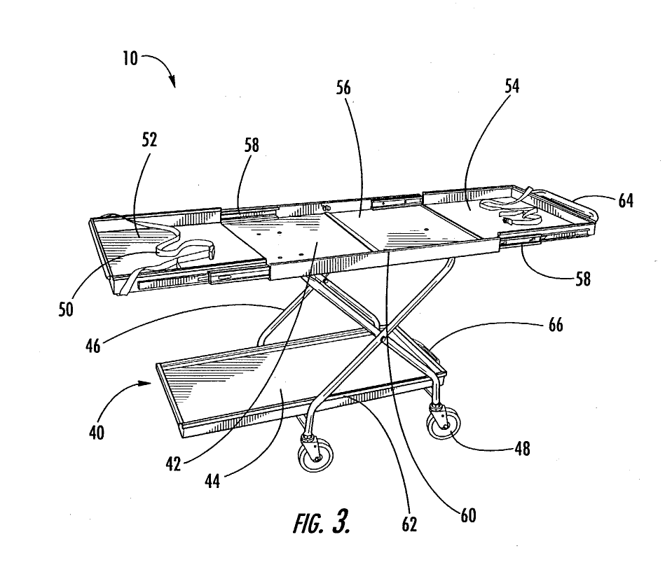

The support frame 46 connects to the top tray 42 proximate the transverse edges of the top tray and to the bottom tray 44 proximate the transverse edges of the bottom tray. The perpendicular distance between the two transverse edges of each tray defines a width of that tray. Likewise, the distance between the two longitudinal edges of each tray defines the length of that tray. As shown in FIG. 1, the width of the top tray 42 is approximately equal to the width of the bottom tray 44. However, other embodiments of the present invention may include a top tray 42 and a bottom tray 44 that have dissimilar widths. In the embodiment shown in FIG. 1 where the cart 40 is in the operable position and the contracted configuration, the height of the cart is approximately 36 inches, the width of the cart is approximately 24 inches, and the length of the top tray 42 of the cart is approximately 40 inches. When the top tray 42 is converted to the extended configuration, as shown in FIG. 3, the top tray 42 can measure up to 80 inches. In the storage position, as shown in FIG. 6, the height of the cart 40 is reduced from 36 inches to approximately 12 inches. The interior dimensions of the storage compartment must be larger than the height, width, and length of the cart 40 in the storage position with the contracted configuration in order for the cart to be stowed in the storage compartment. However, these dimensions are representative only and may vary as required by the intended application.

In the embodiment illustrated in FIG. 1, the transverse edges and longitudinal edges of top tray 42 form right angles at their intersections, as do the transverse edges and longitudinal edges of bottom tray 44. However, other embodiments of the present invention may include edges and intersections forming a variety of geometric orientations, including but not limited to rounded corners, obtuse angles, and acute angles. The edges of top tray 42 include an upward facing lip 60, while the edges of bottom tray 44 include an upward facing lip 62, as shown in FIG. 1. The lips 60 and 62 may prevent items placed on the top tray 42 and the bottom tray 44, respectively, from falling off the trays during transport. The cart 12 also may include a handle 64 on the top tray 42 and a handle 66 on the bottom tray 44 on a longitudinal edge of each tray by which an operator can easily steer the cart when in the operable position or position the cart for storage when in the storage position. Other embodiments may include handles at various locations.

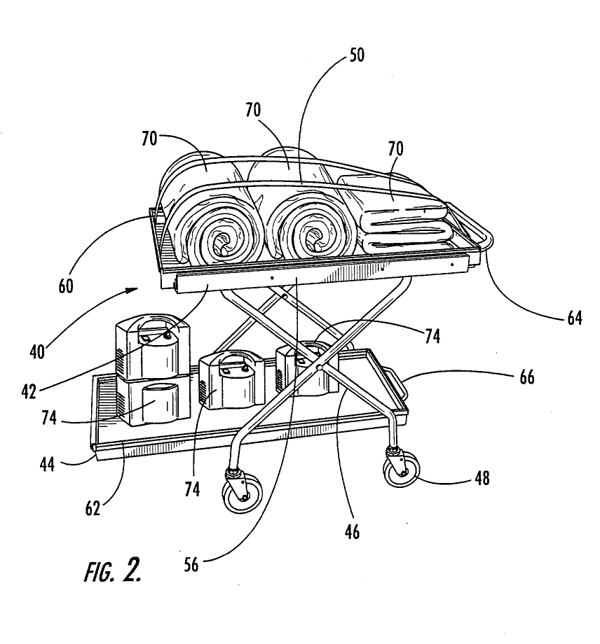

In the contracted configuration of top tray 42 shown in FIG. 2, the top tray is intended to support multiple folded inflatable mattresses 70 during transport to and from the vehicle 12. Straps 50 are preferably included on top tray 42 to secure the inflatable mattresses 70 to the top tray 42, particularly when the operator must stack the inflatable mattresses on the top tray 42. The straps 50 are preferably nylon straps, but the straps may also be made of leather, rope, or bungee material to name a few non-limiting examples. The bottom tray 44 is intended to support accessories of the inflatable mattresses such as pumps 74 and other devices that can be heavy and difficult for operators to manipulate. The cart 40, as shown in FIG. 1 includes a bottom tray 44 that is staggered in the length direction with respect to the top tray 42 so that an operator has better access to the bottom tray 44 to place or remove cumbersome items. FIG. 1 illustrates a staggered bottom tray 44 in which the longitudinal edge opposite the longitudinal edge with the handle 66 protrudes in the length direction beyond the top tray 42 in the contracted configuration. As illustrated, the longitudinal edge with handle 66 remains vertically below the top tray 42 while the opposite longitudinal edge of the bottom tray 44 extends in a length direction from beneath the top tray when the cart 40 is in the operable position. However, non-limiting examples of other embodiments of the present invention may include a bottom tray 44 staggered in an opposite length direction, a bottom tray with longer or shorter overall length than the top tray 42 in the contracted configuration, or no bottom tray at all.

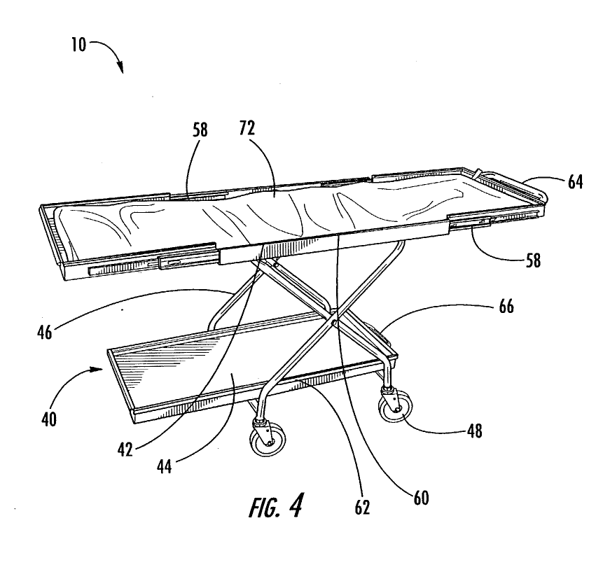

The top tray 42 may be extended from the contracted configuration of FIG. 1 to an extended configuration, as illustrated in FIG. 3. As illustrated in FIG. 4, an advantageous use of the top tray 42 in the extended configuration is to support an unfolded inflatable mattress 72 while an operator disinfects the mattress. The length of the top tray 42 must be sufficiently increased to support the unfolded inflatable or foldable mattress 72 to provide the operator convenient access to the mattress. The embodiment illustrated in FIG. 4 has the entire mattress 72 on the top tray 42 and surrounded by the lip 60, but portions of the mattress are allowed to drape over the lip of the top tray while still providing access to the operator.

The top tray 42 includes a stationary portion 56 that is attached to the support frame 46. Top tray 42 also includes at least one extendable portion, and in the embodiment shown in FIG. 3, the top tray 42 includes two extendable portions shown as first extendable portion 52 and second extendable portion 54. As illustrated in FIG. 3, the first extendable portion 52, the second extendable portion 54, and the stationary portion 56 all include the upward facing lip 60. The first extendable portion 52 and the second extendable portion 54 each include straps 50 and the second extendable portion includes the longitudinal edge with handle 64, though in other embodiments the lip 60, straps, and handle may be positioned in a variety of configurations. The first extendable portion 52 and the second extendable portion 54 are connected to the stationary portion 56 by linear bearings 58, such as roller bearings, in the embodiment shown in FIG. 3. However, any connection device may be substituted for the linear bearings that allow the extendable portions to move in the length direction with respect to the stationary portion 56; non-limiting examples of connecting devices include linear channels to allow relative movement, pinned or hinged connections that allow the extendable portions to rotate outward until level or parallel with the stationary portion 56, or any other connection that allows an extendable portion to extend from or rotate out from the stationary portion to increase the length of the top tray 42.

In the embodiment illustrated in FIG. 1, the cart 40 includes a first extendable portion 52 and a second extendable portion 54 of equal length, though only one extendable portion is required and multiple extendable portions may have differing lengths. The length of each extendable portion 52 or 54 is defined by the distance from the external longitudinal edge to the internal longitudinal edge of each extendable portion. The length of the top tray 42 in the extended configuration is defined by the distance from the external longitudinal edge of the first extendable portion 52 to the external longitudinal edge of the second extendable portion 54. As shown in the contracted configuration of FIG. 1, the extendable portions 52 and 54 are disposed above the stationary portion 56 such that the internal longitudinal edge of the first extendable portion is proximate the internal longitudinal edge of the second extendable portion. The external longitudinal edges of extendable portions 52 and 54 are preferably disposed above the respective longitudinal edges of the stationary portion 56. When converted to the extended configuration as in FIG. 3, the first extendable portion 52 and the second extendable portion 54 are each extended outward such that the internal longitudinal edge of each extendable portion is proximate the respective longitudinal edge of the stationary portion 56. Therefore, substantially no part of the first extendable portion 52 or the second extendable portion 54 is disposed directly above the stationary portion 56 in the extended configuration. Other embodiments may include differing orientations of the extendable portion or portions and the stationary portion 56. The extendable portions do not necessarily have to be extended fully to define the extended configuration but can be only partially extended to increase the overall length of the top tray 42 in the contracted configuration.

The cart 40 may include a locking feature in the top tray 42 to maintain the extendable portions 52 and 54 in the extended configuration or in the contracted configuration. To return the extended top tray 42 to the contracted configuration, the extendable portions 52 and 54 are moved inwardly in the length direction so that the extendable portions overlap the stationary portion 56. However, other embodiments of the present invention may include extendable portions that slide underneath the stationary portion 56 or that overlap each other in the contracted configuration. The length of the top tray 42 in the contracted configuration is measured from the outermost external longitudinal edge of the first extendable portion 52 or the stationary portion 56 to the outermost external longitudinal edge of the second extendable portion 54 or the stationary portion. Other embodiments of the present invention with differently configured top tray portions may define the length in similar manners.

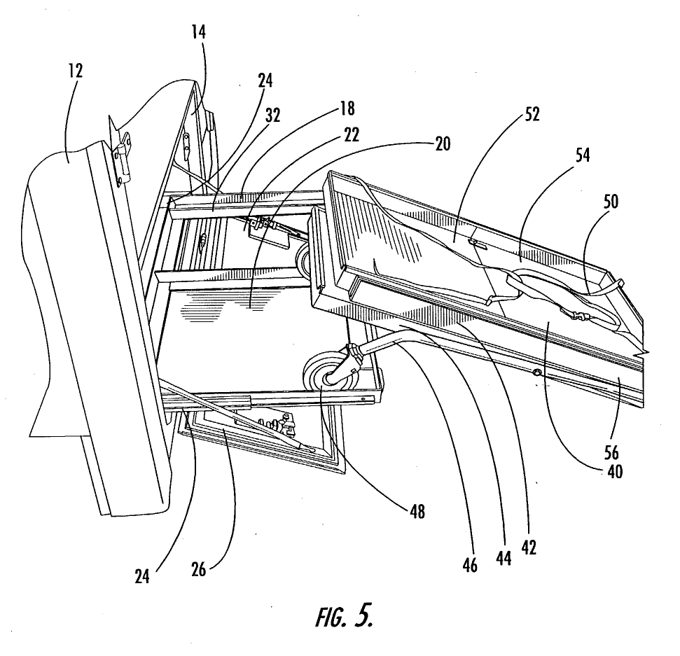

After the cart 40 has been used and is ready to be placed in the storage compartment 14 of the vehicle 12, the cart should be converted to the storage position shown in FIG. 5 and FIG. 6. The length of the top tray 42 must be sufficiently reduced so that the cart 40 may fit within the storage compartment 14. The top tray 42 of cart 40 should be in the contracted configuration so that the top tray has a length less than the interior length dimension of the storage compartment 14. The interior length dimension of the storage compartment 14, as measured between the longitudinal walls of the storage compartment, is limited by the distance between the passenger cabin 28 and the rear wheel well 30 of the vehicle 12, as shown in FIG. 6. The passenger cabin 28 of the vehicle 12 is the portion of the vehicle body for occupants to sit while riding in the vehicle, and the rear wheel well 30 is the portion of the vehicle body that surrounds a rear wheel.

Once the cart 40 has been converted to the storage position, the top tray 42 is proximate the wheels 48 and the bottom tray 44, if included. The height of the cart 40 is measured from the uppermost portion of the top tray 42 of the cart, which is typically the lip 60, to the bottom of the wheels 48. Once in the storage position, the cart 40 is sufficiently short to fit within the interior height dimension of the storage compartment 14 as measured from the top of the interior of the storage compartment to the bottom interior surface of the storage compartment or to the bottom surface 20 of shelf 16 if provided. The storage compartment 14 is advantageously located between a passenger cabin 28 and a rear wheel well 30 of a vehicle 12 and is close to the ground so that an operator can conveniently insert the cart 40. The storage compartment 14 can include a door 26 that opens outward and is hinged near the bottom of the storage compartment such that the door swings out and down as the storage compartment is opened. Other door configurations may also be incorporated in the present invention.

The storage compartment 14 may include a shelf 16 with linear bearings 24 connecting the longitudinal edges of the shelf to the interior longitudinal walls of the storage compartment. The linear bearings 24 allow the shelf 16 to slide in the width direction out of the storage compartment 14 from an interior position to an exterior position. Other embodiments of the present invention may provide differing attachments of the shelf 16 to the storage compartment 14 or provide no shelf at all, in which case the cart 40 may be inserted directly into the storage compartment.

Once the shelf 16 has been extended to the exterior position that is substantially outside the storage compartment 14, the cart 40 in the storage position may be placed onto the shelf. To conveniently place the cart 40 onto the shelf 16, the operator may lift the longitudinal end of the cart opposite the end with the handles 64 and 66 and place two wheels 48 of the cart onto the bottom surface 20 of the shelf, as illustrated in FIG. 5. By placing only two of the four wheels 48 of the illustrated embodiment of the cart 40 onto the shelf 16, the operator need not lift the entire weight of the cart. To place the entire cart 40 onto the shelf 16, as is shown in FIG. 6, the operator lifts the cart by the handle 66 on the bottom tray 44 and rotates the cart 40 so that both of the two wheels 48 resting on the shelf in FIG. 5 contact the longitudinal edge of the shelf. At this point, the operator would be suspending the opposite side of the cart 40 directly above the shelf 16 and need only lower the raised side of the cart down onto the shelf. As shown in FIG. 1, the shelf 16 includes an upward facing lip 18 that surrounds the perimeter of the shelf 16 so that the cart 40 is retained on the shelf when all four wheels 48 are placed on the shelf. A lip 18 with a height of one or two inches is sufficient to retain the cart 40 on the shelf 16. The shelf 16 also includes an interior lip 32 that also faces upwards to retain the two wheels 48 proximate the handle 66 of bottom tray 44. However, other embodiments of the present invention may have no lip or may incorporate other retention devices analogous to the upward facing lips.

The overall length of the shelf 16 is defined by the distance between a first longitudinal edge and a second longitudinal edge. As illustrated in FIG. 1, the bottom surface 20 of shelf 16 extends in the length direction from the first longitudinal edge of shelf approximately half the length of the shelf. A bottom opening 22 is thus defined where the shelf 16 includes no bottom surface 20 that is circumscribed by an inwardly projecting, upwardly facing flange extending from the upward facing lip 18 of the shelf perimeter as shown in FIG. 1 and FIG. 5. An upward facing lip also separates the bottom surface 20 from the bottom opening 22. The bottom opening 22 minimizes the material required to manufacture the shelf 16 while still providing sufficient surface area to enable an operator to rotate the cart 40 onto the shelf. The bottom opening 22 may also provide additional access to the cart 40 while the cart is supported by the shelf 16.

Once the cart 40 is completely supported by the shelf 16 such that no portion of the cart extends beyond the shelf in either the width or length directions, the shelf may be slid from the exterior position to the interior position so that the cart is located within the storage compartment 14. The door 26 may be closed and the cart 40 is completely stowed within the storage compartment and can be transported with the vehicle 12. Therefore, the cart 40 is transported without exposure to contaminants so that the cart will remain sufficiently clean to transport mattresses 70 and pumps 74 when subsequently removed from the storage compartment 14. Other embodiments of the invention may include other features to insert the cart 40 into the storage compartment 14 or secure the cart within the storage compartment once the cart is disposed inside the storage compartment. The cart 40 may be removed from the storage compartment 14 in a reverse order that it was inserted, just as the cart may be converted from the storage position to an operable position and from the contracted configuration to the extended configuration in reverse order. The cart 40 and storage compartment 14 are preferably manufactured from metals such as steel or aluminum to list non-limiting examples, but other materials with sufficient material strengths can be substituted.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for transporting and cleaning beds including foldable mattresses, comprising:
a vehicle comprising;
a passenger compartment,
a rear wheel well, and
a storage compartment on a side of the vehicle located between said passenger compartment and said rear wheel well, said storage compartment having an interior height dimension and having an interior length dimension that is less than the length of an unfolded mattress, and
a cart for transporting the foldable mattresses, comprising;
a top tray defining a length,
a plurality of wheels,
a support frame for supporting said top tray on said wheels, said support frame allowing said cart to move in the height direction to be converted from an operable position where said top tray is elevated substantially above said wheels to a storage position where said top tray is lowered to be proximate said wheels, and
wherein said top tray includes at least one extendable portion that is extendable in a length direction such that said top tray can be converted from a contracted configuration to an extended configuration by extending said at least one extendable portion, and wherein the length of said top tray in the extended configuration is sufficiently increased to support an unfolded mattress for cleaning operations to be performed on the mattress, and wherein the length of said top tray in the contracted configuration is sufficiently reduced to be placed within said storage compartment.

2. A system according to claim 1, wherein the length of said top tray in the extended configuration is approximately twice as long as the length of said top tray in the contracted configuration.

3. A system according to claim 1, wherein said extendable portion defines a length,
wherein said top tray includes a stationary portion having longitudinal edges separated by a length of said stationary portion, and
wherein said top tray further includes a second extendable portion having a length approximately equal to the length of the first extendable portion, such that the lengths of said first extendable portion and of said second extendable portion are each approximately half the length of said stationary portion.

4. A system according to claim 3, wherein said first extendable portion and said second extendable portion are proximate one another and are each disposed directly above said stationary portion when said top tray is in the contracted configuration.

5. A system according to claim 3, wherein said first extendable portion and said second extendable portion are separated from one another by a distance approximately equal the length of said stationary portion when said top tray is in the extended configuration.

6. A system according to claim 1, wherein said support frame includes two scissor-like supports that each include a pivot point, two upper ends attached to said top tray, and two lower ends attached to said wheels, said upper ends expand in the length direction away from each other as said top tray is vertically lowered relative to said wheels and said lower ends expand in the length direction away from each other as said top tray is vertically lowered relative to said wheels.

7. A system according to claim 6, wherein said cart further comprises a bottom tray disposed below said top tray and proximately above said wheels and between said two scissor-like supports.

8. A system according to claim 7, wherein said bottom tray is staggered in the length direction relative to said top tray.

9. A system according to claim 1, wherein said top tray includes at least one strap for retaining the foldable mattresses.

10. A system according to claim 1, wherein said storage compartment further comprises a shelf for retaining said cart that may be converted from an interior position within said storage compartment to an exterior position substantially outside said storage compartment.

11. A system according to claim 10, wherein said shelf defines a length longer than the length of said top tray of said cart in the contracted configuration such that said cart may be positioned on said shelf in the exterior position without any portion of said cart in the storage position extending beyond said shelf in the length direction.

12. A system according to claim 10, wherein said shelf defines a perimeter and includes an upward facing lip along the perimeter of said shelf.

13. A system according to claim 10, wherein said shelf of said storage compartment includes a bottom surface, a first longitudinal edge, and a second longitudinal edge, and defines a length of said shelf from said first longitudinal edge to said second longitudinal edge, and
wherein said bottom surface extends an entire width of said shelf and extends in the length direction from said first longitudinal edge of said shelf approximately half the length of said shelf such that said bottom surface provides a surface for approximately half of said shelf and defines a bottom opening in said shelf between said bottom surface and said second longitudinal edge.

14. A cart for transporting foldable mattresses, for providing a surface to clean unfolded mattresses, and for stowing in a storage compartment on a vehicle, comprising:
a top tray defining a length that includes at least one extendable portion that is extendable in a length direction such that said top tray can be converted from a contracted configuration to an extended configuration by extending said at least one extendable portion;
a plurality of wheels, said wheels defining a height of said cart from the bottom of said wheels to an uppermost portion of said top tray of said cart;
a support frame for supporting said top tray on said wheels, said support frame allowing said cart to move in the height direction to be converted from an operable position where said top tray is elevated substantially above said wheels to a storage position where said top tray is lowered to be proximate said wheels; and
wherein the length of said top tray in the extended configuration is sufficiently increased to support an unfolded mattress for cleaning operations to be performed on the mattress, and wherein the length of said top tray in the contracted configuration is sufficiently reduced to be placed within the storage compartment, and wherein the height of said cart in the storage position is sufficiently short to be placed within the storage compartment.

15. A cart according to claim 14, wherein said top tray in the extended configuration provides a length approximately twice as long as the length of said top tray in the contracted configuration.

16. A cart according to claim 14, wherein said extendable portion defines a length,
wherein said top tray includes a stationary portion having longitudinal edges separated by a length of said stationary portion, and
wherein said top tray further includes a second extendable portion having a length approximately equal to the length of the first extendable portion, such that the lengths of said first extendable portion and of said second extendable portion are each approximately half the length of said stationary portion.

17. A cart according to claim 16, wherein said first extendable portion and said second extendable portion are proximate one another and are each disposed directly above said stationary portion when said top tray is in the contracted configuration.

18. A cart according to claim 16, wherein said first extendable portion and said second extendable portion are separated from one another by a distance approximately equal the length of said stationary portion when said top tray is in the extended configuration.

19. A cart according to claim 14, wherein said support frame includes two scissor-like supports that each include a pivot point, two upper ends attached to said top tray, and two lower ends attached to said wheels, said upper ends expand in the length direction away from each other as said top tray is vertically lowered relative to said wheels and said lower ends expand in the length direction away from each other as said top tray is vertically lowered relative to said wheels.

20. A cart according to claim 19, wherein said cart further comprises a bottom tray disposed below said top tray and proximately above said wheels and between said two scissor-like supports, wherein said bottom tray is staggered in the length direction relative to said top tray.

21. A cart according to claim 14, wherein said top tray includes at least one strap for retaining the foldable mattresses.

22. A system for transporting and cleaning beds including foldable mattresses, comprising:
a vehicle comprising;
a passenger compartment,
a rear wheel well, and
a storage compartment on a side of the vehicle located between said passenger compartment and said rear wheel well, said storage compartment having an interior height dimension and having an interior length dimension that is less than the length of an unfolded mattress, and
a cart for transporting the foldable mattresses, comprising;
a top tray defining a length and including a stationary portion, a first extendable portion, and a second extendable portion,
a plurality of wheels,
a support frame for supporting said top tray on said wheels, said support frame allowing said cart to move in the height direction to be converted from an operable position where said top tray is elevated substantially above said wheels to a storage position where said top tray is lowered to be proximate said wheels, said support frame including two scissor-like supports that each include a pivot point, two upper ends attached to said top tray, and two lower ends attached to said wheels, said upper ends expand in a length direction away from each other as said top tray is vertically lowered relative to said wheels and said lower ends expand in the length direction away from each other as said top tray is vertically lowered relative to said wheels,
a bottom tray disposed below said top tray and proximately above said wheels and between said two scissor-like supports of said support frame, and
wherein said first extendable portion and said second extendable portion are extendable in the length direction in opposite directions such that said top tray can be converted from a contracted configuration to an extended configuration by extending said first extendable portion and said second extendable portion, and wherein the length of said top tray in the extended configuration is sufficiently increased to support an unfolded mattress for cleaning operations to be performed on the mattress, and wherein the length of said top tray in the contracted configuration is sufficiently reduced to be placed within said storage compartment.

23. A system according to claim 22, wherein said storage compartment further comprises a shelf for retaining said cart that may be converted from an interior position within said storage compartment to an exterior position substantially outside said storage compartment.
